(19) United States
(12) Patent Application Publication
(10) Pub. No.: US 2014/0028209 A1
(43) Pub. Date: Jan. 30, 2014

(54) INTERFACE CIRCUIT AND INTERFACE METHOD

(71) Applicants: Noriyuki Kitamura, Kanagawa-ken (JP); Toru Ishikita, Kanagawa-ken (JP); Toshihiko Sasai, Kanagawa-ken (JP); Hiroshi Akahoshi, Kanagawa-ken (JP); Hirokazu Otake, Kanagawa-ken (JP); Yuji Takahashi, Kanagawa-ken (JP)

(72) Inventors: Noriyuki Kitamura, Kanagawa-ken (JP); Toru Ishikita, Kanagawa-ken (JP); Toshihiko Sasai, Kanagawa-ken (JP); Hiroshi Akahoshi, Kanagawa-ken (JP); Hirokazu Otake, Kanagawa-ken (JP); Yuji Takahashi, Kanagawa-ken (JP)

(73) Assignee: Toshiba Lighting & Technology Corporation, Kanagawa-ken (JP)

(21) Appl. No.: 13/617,940

(22) Filed: Sep. 14, 2012

(30) Foreign Application Priority Data
Jul. 27, 2012 (JP) 2012-167632

(51) Int. Cl. H05B 37/00

(52) U.S. Cl. 315/200 R

(57) ABSTRACT

Disclosed is an interface circuit including a rectifier circuit, a detection circuit, a first circuit, and a second circuit. The rectifier circuit rectifies an AC voltage input between a pair of input terminals. The detection circuit detects the AC voltage and outputs the result as a detection voltage. The first circuit is controlled to be turned on or off on the basis of an input first control signal, to cause a first current to flow between the input terminals in an on state and to cut off the first current in an off state. The second circuit is controlled to be turned on or off on the basis of an input second control signal, to allow a second current greater than the first current to flow between the input terminals in an on state and to cut off the second current in an off state.

### CROSS-REFERENCE TO RELATED APPLICATIONS

This application is based upon and claims the benefit of priority from Japanese Patent Application No. 2012-167632, filed on Jul. 27, 2012; the entire contents of which are incorporated herein by reference.

### FIELD

Exemplary embodiments described herein relate to an interface circuit and an interface method.

### BACKGROUND

Recently, in an illumination light source of a lighting device, a light bulb or a fluorescent lamp has been replaced with alight source having an energy saving characteristic and long durability, for example, a light-emitting diode (LED). Further, for example, a new illumination light source such as an electro-luminescence (EL) or an organic light-emitting diode (OLED) has been developed.

A two-wire dimmer has been configured to control a phase where a triac is turned on, and has spread as a dimmer of a light bulb. Such a dimmer employs a phase control configuration of controlling a conduction phase between the zero-crossing of an AC voltage and a maximum value thereof and a reverse phase control configuration of controlling a cut-off phase between the maximum value and the zero-crossing. Thus, it is desirable that an illumination light source such as an LED also be dimmed by such a dimmer.

### BRIEF DESCRIPTION OF THE DRAWINGS

FIG. 1 is a circuit diagram illustrating an interface circuit according to a first embodiment;

FIG. 2 is a circuit diagram illustrating a phase control dimmer;

FIG. 3 is a circuit diagram illustrating a reverse phase control dimmer;

FIGS. 4A to 4E are waveform charts illustrating main signals of an interface circuit when a dimmer is not present;

FIGS. 5A to 5E are waveform charts illustrating the main signals of an interface circuit when a phase control dimmer is present;

FIGS. 6A to 6E are waveform charts illustrating the main signals of an interface circuit when a reverse phase control dimmer is present;

FIG. 7 is a circuit diagram illustrating an interface circuit according to a second embodiment;

FIG. 8 is a diagram schematically illustrating operations of first and second circuits in an interface circuit;

FIG. 9 is a circuit diagram illustrating an interface circuit according to a third embodiment;

FIG. 10 is a flowchart illustrating an operation of a control circuit; and

FIG. 11 is another flowchart illustrating an operation of a control circuit.

### DETAILED DESCRIPTION

In general, according to one embodiment, an interface circuit includes a rectifier circuit, a detection circuit, a first circuit, and a second circuit. The rectifier circuit rectifies an AC voltage which is input between a pair of input terminals. The AC voltage is subject to phase control or reverse phase control by a dimmer, or is continuous in phase without passing through the dimmer. The detection circuit detects the AC voltage and outputs the result as a detection voltage. The first circuit is controlled to be turned on or turned off on the basis of a first control signal which is input, to allow a first electric current to flow between the pair of input terminals in an on state, and to cut off the first electric current in an off state. The second circuit is controlled to be turned on or turned off on the basis of a second control signal input, to allow a second electric current which is greater than the first electric current to flow between the pair of input terminals in an on state, and to cut off the second electric current in an off state.

Hereinafter, embodiments will be described in detail with reference to the accompanying drawings. In the specification and the drawings, the same reference numerals are given to the same elements as those described with reference to the previous drawings, and detailed description thereof will be appropriately omitted.

### First Embodiment

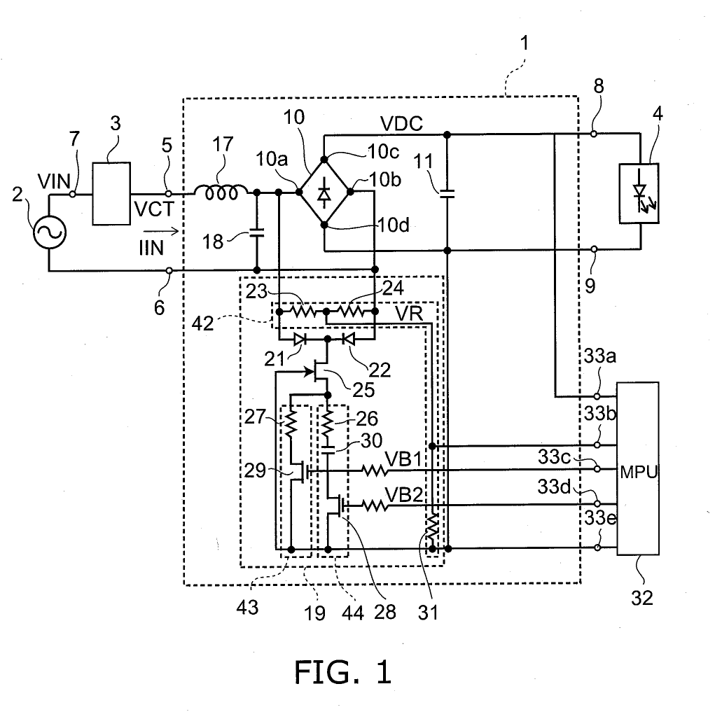

FIG. 1 is a circuit diagram illustrating an interface circuit according to a first embodiment.

The interface circuit 1 according to the first embodiment is an interface circuit which receives an AC voltage VCT supplied from an AC power source 2 through a dimmer 3, a first control signal VB1 and a second control signal VB2, and then outputs a DC voltage VDC to a lighting device 4 or the like, for example. The lighting device 4 includes an illumination light source such as a light emitting diode (LED), and is supplied with electric power from the AC power source 2 through the interface circuit 1 for lighting. Further, the lighting device 4 may be dimmed by the dimmer 3 through the interface circuit 1.

The AC power source 2 is a commercial power source, for example. Further, in the embodiment, a configuration in which the dimmer 3 is inserted in series between a part of terminals 5 and 7 of one of a pair of power source lines which supplies a power source voltage VIN is used, but a different configuration may be used. Further, a configuration in which the dimmer 3 is not used may be used.

The dimmer 3 generally includes a phase control (leading edge) type of controlling a conduction phase in a period from the zero-crossing of an AC voltage to a point when an absolute value of the AC voltage is a maximum value, and a reverse phase control (trailing edge) type of controlling a cut-off phase in a period from the point when the absolute value of the AC voltage reaches the maximum value to the zero-crossing of the AC voltage.

The phase control dimmer has a simple circuit configuration and can handle relatively large electric power load. However, when a triac is used, a light-load operation is not likely to be achieved, and if a so-called power source dipping in which the power source voltage is temporally reduced occurs, an unstable operation is likely to occur. Further, when a capacitive load is connected, a rush current is generated, and thus, compatibility with the capacitive load deteriorates.

On the other hand, the reverse phase control dimmer is operable under a light load, and even though the capacitive load is connected, the rush current is not generated. Further, even though the power source dipping occurs, the operation is stable. However, the circuit configuration is complicated and the temperature is easily increased, and thus, it is not suitable for a heavy load. Further, when an inductive load is connected, for example, a surge occurs.

As the load of the dimmer, for example, when a low impedance component such as a light bulb is connected, since an electric current flows at all the phases of the AC voltage, the dimmer does not malfunction. However, as the load of the dimmer, for example, when a lighting circuit for lighting an illumination light source such as an LED is connected, input impedance is changed according to the phase of the AC voltage, and thus, the dimmer may malfunction. Thus, the interface circuit 1 according to the embodiment allows an electric current to flow depending on the presence or absence of the dimmer and depending on the phase control or reverse phase control type of the dimmer when the dimmer is connected, to thereby stably operate the dimmer.

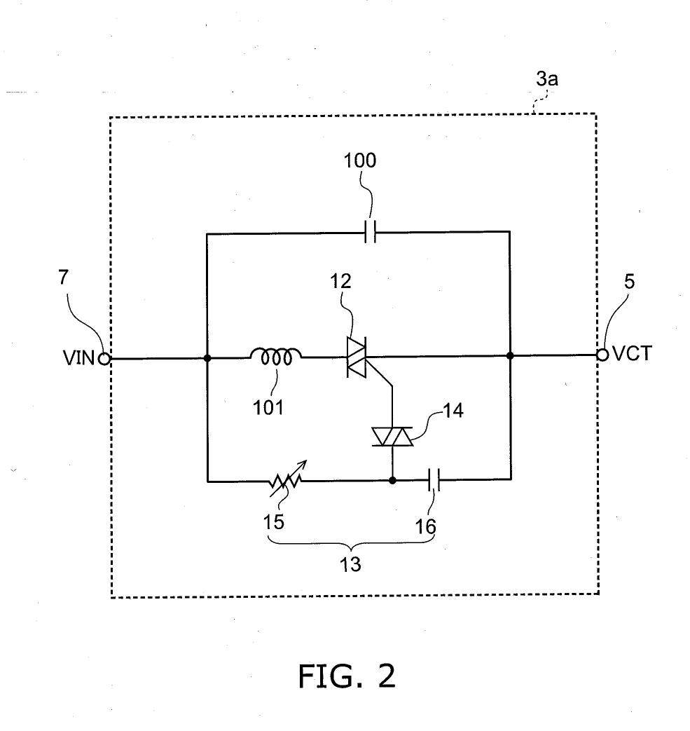

FIG. 2 is a circuit diagram illustrating a phase control dimmer.

A dimmer 3a includes a triac 12 which is inserted in series with a power source line, an inductor 100 which is connected in series with the triac 12, a phase circuit 13 which is connected in parallel with the triac 12 and a serial circuit of the inductor 100, a DIAC 14 which is connected between a gate of the triac 12 and the phase circuit 13, and a filter capacitor 101 which is connected in parallel with the triac 12 and the serial circuit of the inductor 100.

The triac 12 is normally in a state where main electrodes are cut off, and is conducted when a pulse signal is input to agate. The triac 12 is capable of allowing an electric current to flow therein in both directions when the AC power source voltage VIN is a positive polarity and a negative polarity.

The phase circuit 13 includes a variable resistor 15 and a timing capacitor 16, and generates a phase-delayed voltage at the opposite ends of the timing capacitor 16. Further, if a resistance value of the variable resistor 15 is changed, a time constant is changed and a delay time is changed.

The DIAC 14 generates a pulse voltage when voltage charged in a capacitor of the phase circuit 13 exceeds a predetermined value, and conducts the triac 12.

By controlling the timing when the time constant of the phase circuit 13 is changed and the DIAC 14 generates the pulse, it is possible to adjust the timing when the triac 12 is conducted. Accordingly, the dimmer 3a can adjust the conduction period of phase control at the AC voltage VCT.

The inductor 100 reduces the change rate di/dt of electric current i so as to prevent breakdown of the triac 12. The filter capacitor 101 is provided as a filter of the inductor 100 to prevent noise.

A possible range of phase control has a minimum width of 10% to 25% of a half cycle of the power source voltage VIN, for example. For example, when the AC power source 2 is a commercial power source of a frequency of 50 Hz, the half cycle is 10 ms, and the minimum duration is 1 ms to 2.5 ms. Further, an absolute value of the AC voltage VCT passed through the dimmer 3a is about 25% to 65% of a maximum value which is a peak value. For example, when the AC power source 2 is a commercial power source of an effective value of 100 V, its peak voltage is 141 V, and the AC voltage VCT which may be generated is 30 V to 90 V.

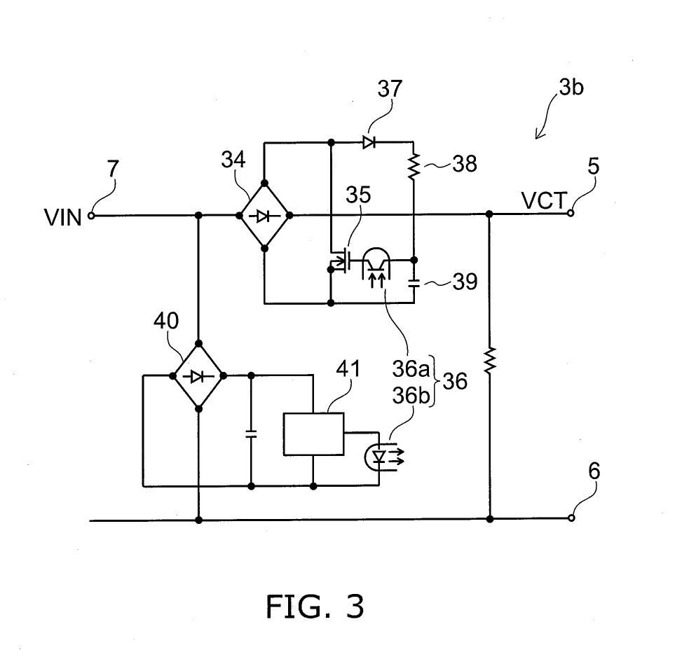

FIG. 3 is a circuit diagram illustrating a reverse phase control dimmer.

A dimmer 3b includes rectifier circuits 34 and 40, a semiconductor switch 35, a photo coupler 36, a diode 37, a resistor 38, a capacitor 39 and a dimming control circuit 41.

The rectifier circuit 34 is inserted in series on one side of a pair of power source lines. The semiconductor switch 35 is an FET, for example, and is connected between a pair of output terminals of the rectifier circuit 34. Further, between the pair of output terminals of the rectifier circuit 34, the diode 37, the resistor 38 and the capacitor 39 are connected in series, to form a bias circuit for conducting the semiconductor switch 35.

The photo coupler 36 includes a light receiving element 36a and a light emitting element 36b. The light receiving element 36a is connected between a control terminal (gate) of the semiconductor switch 35 and the capacitor 39 which forms the bias circuit. When the light receiving element 36a of the photo coupler 36 is conducted, the voltage of the capacitor 39 is applied to a control terminal of the semiconductor switch 35.

The rectifier circuit 40 is connected in parallel with the pair of power source lines. The dimming control circuit 41 is connected between a pair of output terminals of the rectifier circuit 40. Further, the light emitting element 36b of the photo coupler 36 is connected to an output of the dimming control circuit 41. If the light emitting element 36b emits light, the light receiving element 36a is conducted, and the voltage of the capacitor 39 is applied to the control terminal of the semiconductor switch 35. As a result, the semiconductor switch 35 is conducted and the dimmer 3b enters a conduction state. Further, when the light emitting element 36b does not emit light, the light emitting element 36a is cut off, the semiconductor switch 35 is cut off, and the dimmer 3b enters a cut off state.

The dimming control circuit 41 includes a microcomputer or a microprocessor (MPU), for example, and adjusts the timing when the light emitting element 36b emits light and controls the conduction period of phase control at the input power source voltage VIN for dimming.

A possible range of the reverse phase control has a minimum width of 10% to 35% of a half cycle of the power source voltage VIN, for example. For example, when the AC power source 2 is a commercial power source of a frequency of 50 Hz, the half cycle is 10 ms, and the minimum duration is 1 ms to 3.5 ms.

Returning to FIG. 1, the interface circuit 1 includes a rectifier circuit 10, a smoothing capacitor 11, a choking coil 17, a capacitor 18, and a load circuit 19.

The rectifier circuit 10 includes a diode bridge. Input terminals 10a and 10b of the rectifier circuit 10 are connected to a pair of input terminals 5 and 6 through the choking coil 17. An AC voltage VCT which is subject to phase control or reverse phase control through the dimmer 3 is input to the input terminals 10a and 10b of the rectifier circuit 10. In the embodiment, a configuration in which the dimmer 3 is used is shown, but a configuration in which the dimmer 3a or 3b is provided may be used, and a configuration in which the dimmer is not provided may be used.

The smoothing capacitor 11 is connected to a high electric potential terminal 10c and a low electric potential terminal 10d of the rectifier circuit 10, and a DC voltage VDC which is smoothed is generated at the opposite ends of the smoothing capacitor 11. The DC voltage VDC is output from output terminals 8 and 9 as an output voltage of the dimming interface circuit 1. In this regard, the rectifier circuit 10 may have a different configuration as long as the AC voltage VCT input from the dimmer 3 can be rectified.

The load circuit 19 is connected to the input terminals 10a and 10b of the rectifier circuit 10, and allows an electric current to flow to the pair of input terminals 5 and 6 through the choking coil 17. The load circuit 19 includes a pair of rectifier elements 21 and 22, a switching element 25, a detection circuit 42, a first circuit 43, a second circuit 44, and the like.

The pair of rectifier elements 21 and 22 is a diode, for example, and respective anodes thereof are connected to the pair of input terminals 5 and 6 through the choking coil 17. Further, respective cathodes thereof are connected to the pair of rectifier elements 21 and 22, and the pair of rectifier elements 21 and 22 is connected to the pair of input terminals 5 and 6 in series in a direction of reverse conduction.

The switching element 25 is an FET, for example, and is a GaN-HEMT, for example, which is an element of a normally-on type. A drain of the switching element 25 is connected to the cathode of the rectifier element 21 and the cathode of the rectifier element 22, and a source of the switching element 25 is connected to the low electric potential terminal 10d through the first circuit 43 and the second circuit 44, and a gate of the switching element 25 is connected to the low electric potential terminal 10d.

The detection circuit 42 includes a resistor (first resistor) 23, a resistor (second resistor) 24, and a resistor (third resistor) 31. The resistors 23 and 24 are connected in series with the pair of input terminals 5 and 6 through the choking coil 17. A resistance value of the resistor 23 and a resistance value of the resistor 24 are set to be the same. Further, the resistor 31 is connected between a connect point of the resistors 23 and 24 and the low electric potential terminal 10d. The voltage of the opposite ends of the resistor 31 is output as a detection voltage VR obtained by detecting an absolute value of the AC voltage VCT. The detection voltage VR is output to the microprocessor 32 through the control terminal 33b.

The first circuit 43 includes a resistor 27 and transistor 29. An end of the resistor 27 is connected to the source of the switching element 25, and the other end of the resistor 27 is connected to a drain of the transistor 29. A source of the transistor 29 is connected to the low electric potential terminal 10d, and a gate of the transistor 29 is connected to the microprocessor 32 through a resistor and a control terminal 33c. A first control signal VB1 is input to a gate of the transistor 29 from the microprocessor 32.

The second circuit 44 includes a resistor 26, a transistor 28, and a capacitor 30. An end of the resistor 26 is connected to the source of the switching element 25, and the other end of the resistor 26 is connected to a drain of the transistor 28 through the capacitor 30. A source of the transistor 28 is connected to the low electric potential terminal 10d, and a gate of the transistor 28 is connected to the microprocessor 32 through a resistor and a control terminal 33d. A second control signal VB2 is input to the gate of the transistor 28 from the microprocessor. The transistors 28 and 29 are FETs, for example, and are N channel type MOSFETs (NMOS).

Further, the microprocessor 32 is connected to the high electric potential terminal 10c and the low electric potential terminal 10d through control terminals 33a and 33e, respectively. An electric potential of the low electric potential terminal 10d as a reference electric potential, and an electric potential of the high electric potential terminal 10c as an electric potential of the smoothing capacitor 11 are respectively input to the microprocessor 32. The microprocessor 32 outputs the first control signal VB1 and the second control signal VB2 for controlling the interface circuit 1 to the control terminals 33c and 33d on the basis of the signals input through the control terminals 33a, 33b and 33e.

Next, an operation of the interface circuit 1 in a case where the dimmer is not present, a case where the phase control dimmer 3a is present and a case where the reverse phase control dimmer 3b is present will be sequentially described.

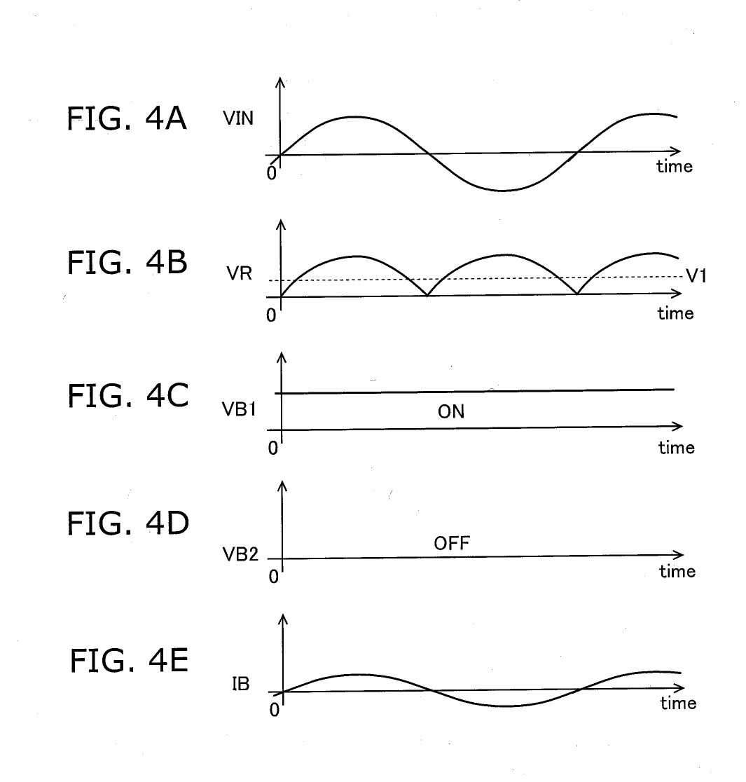

FIGS. 4A to 4E are waveform charts illustrating main signals of an interface circuit when a dimmer is not present. Here, FIG. 4A shows a power source voltage VIN, FIG. 4B shows a detection voltage VR, FIG. 4C shows a first control signal VB1, FIG. 4D shows a second control signal VB2, and FIG. 4E shows an electric current IB.

Since the embodiment has a configuration in which a dimmer is not present, an AC voltage VCT input to the interface circuit 1 is the same as the power source voltage VIN of the AC power source 2.

The AC power source 2 is a commercial power source of a frequency of 50 Hz and a voltage of 100 V, for example. Further, the power source voltage VIN of the AC power source 2 passes through the zero-crossing, and thus, for example, the power source voltage VIN has a phase where the input terminal 5 is a positive polarity and the input terminal 6 is a negative polarity. The AC voltage VCT (=VIN) is supplied to a drain of the switching element 25 through the rectifier element 21. Since the switching element 25 is a normally-on element, the switching element 25 is turned on.

Further, the rectifier element 22 is in a cut off state.

The detection voltage VR is a voltage obtained by dividing the absolute value of the power source voltage VIN by the resistors 23 and 31, and changes according to the power source voltage VIN (FIGS. 4A and 4B).

Further, the first control signal VB1 is at a high level (FIG. 4C), and the transistor 29 is thus turned on. As a result, the first circuit 43 is controlled to be turned on, a space between the input terminal 10b and the low electric potential terminal 10d in the rectifier circuit 10 is in a conduction state, and the first electric current flows between the pair of input terminals 5 and 6 (FIG. 4E). The second control signal VB2 is at a low level (FIG. 4D), and the transistor 28 is thus turned off. As a result, the second circuit 44 is controlled to be turned off, and the second electric current is thus cut off.

If time elapses and the phase of the power source voltage VIN proceeds, the detection voltage VR passes through the maximum value and then gradually decreases (FIG. 4A). The first circuit 43 allows the first electric current to flow between the input terminals 5 and 6.

If the power source voltage VIN passes through the zero-crossing and the polarity of the power source voltage VIN is reversed, and thus, if the input terminal 5 is a negative polarity and the input terminal 6 is a positive polarity, the rectifier element 21 is turned off. In this case, operations are the same as in the above description except that the operations of the rectifier elements 21 and 22 and the operations of the resistors 23 and 24 are respectively replaced with each other.

Next, if the power source voltage VIN passes through the zero-crossing and the polarity of the power source voltage VIN is reversed, and thus, if the input terminal 5 is a positive polarity and the input terminal 6 is a negative polarity, the rectifier element 22 returns to the turned off state, and then, the same operations are repeated.

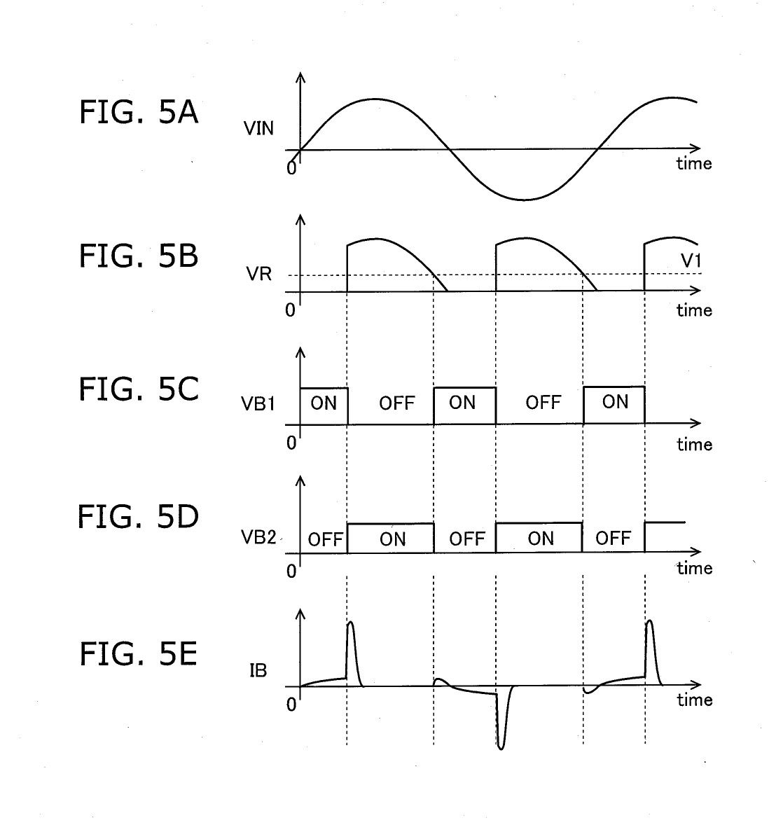

FIGS. 5A to 5E are waveform charts illustrating the main signals of an interface circuit when the phase control dimmer 3a is present. Here, FIG. 5A shows a power source voltage VIN, FIG. 5B shows a detection voltage VR, FIG. 5C shows a first control signal VB1, FIG. 5D shows a second control signal VB2, and FIG. 5E shows an electric current IB.

Since the embodiment has a configuration in which the phase control dimmer 3a is present, an AC voltage VCT input to the interface circuit 1 is the same as the power source voltage VIN of the AC power source 2 when the dimmer 3a is in a conduction state. Further, the AC power source 2 is a commercial power source of a frequency of 50 Hz and a voltage of 100 V.

The power source voltage VIN of the AC power source 2 passes through the zero-crossing, and thus, for example, the power source voltage VIN has a phase where the input terminal 5 is a positive polarity and the input terminal 6 is a negative polarity (FIG. 5A). Since the dimmer 3a is in a cut off state, the absolute value of the AC voltage VCT maintains a small value, and the power source voltage VIN is applied to the dimmer 3a.

In a period when the detection voltage VR is lower than a specified value V1, a high level is input as the first control signal VB1 (FIGS. 5B and 5C). The first circuit 43 is controlled to be turned on, and the first electric current flows between the input terminals 5 and 6. Further, in a period when the detection voltage VR is lower than the specified voltage V1, a low level is input as the second control signal VB2 (FIGS. 5B and 5D). The second circuit 44 is controlled to be turned off, and thus, the second electric current does not flow. As a result, the first electric current flows between the input terminals 5 and 6 as the electric current IB (FIG. 5E).

If the absolute value of the power source voltage VIN of the AC power source 2 increases and the dimmer 3a is conducted, the AC voltage VCT is approximately the same as the power source voltage VIN. As a result, the detection voltage VR increases to be equal to or higher than the specified value V1 (FIG. 5B), and a low level is input as the first control signal VB1 (FIG. 5C). The first circuit 43 is controlled to be turned off, and the first electric current is thus cut off.

Further, when the detection voltage VR is equal to or higher than the specified value V1, a high level is input as the second control signal VB2 (FIG. 5D). The transistor 28 in the second circuit 44 is turned on, and thus, a charging current flows as a second electric current in a capacitor 30 through a resistor 26. The capacitor 30 is charged by the charging current, and thus, a source electric potential of the switching element 25 increases. If the voltage (negative polarity) between the gate and source of the switching element 25 is lower than a threshold voltage, the switching element 25 is turned off. As a result, the second electric current flows as a pulse electric current (FIG. 5E). A peak value of the second electric current is set to be greater than the first electric current, to thereby completely turn on the dimmer 3a.

In a period when the phase of the power source voltage VIN proceeds and the detection voltage VR is lower than the specified value V1, a high level is input as the first control signal VB1 (FIGS. 5B and 5C). The first circuit 43 is controlled to be turned on, and thus, the first electric current flows between the input terminals 5 and 6. During this period, a low level is input as the second control signal VB2 (FIGS. 5B and 5D). The second circuit 44 is controlled to be turned off. As described above, since the second electric current corresponds to a pulse current, the second electric current is already sufficiently smaller than the first electric current, and thus, the electric current IB between the input terminals 5 and 6 reaches the first electric current.

If the power source voltage VIN passes through the zero-crossing and the polarity of the power source voltage VIN is reversed, and thus, if the input terminal 5 becomes a negative polarity and the input terminal 6 becomes a positive polarity, the rectifier element 21 is turned off. Operations in this case are the same as in the above description except that the operations of the rectifier elements 21 and 22 and the operations of the resistors 23 and 24 are respectively replaced with each other.

Next, if the power source voltage VIN passes through the zero-crossing and the polarity of the power source voltage VIN is reversed, and thus, if the input terminal 5 becomes a positive polarity and the input terminal 6 becomes a negative polarity, the rectifier element 22 returns to the turned off state, and then, the same operations are repeated.

In the embodiment, a configuration is used in which the second circuit 44 includes the capacitor 30 and a signal which reaches a high level when the detection voltage VR is equal to or higher than the specified value V1 is input as the second control signal VB2. However, the capacitor 30 may be removed from the second circuit 44, and a pulse signal of a predetermined width which reaches a high level when the detection voltage VR is equal to or higher than the specified value V1 may be input as the second control signal VB2.

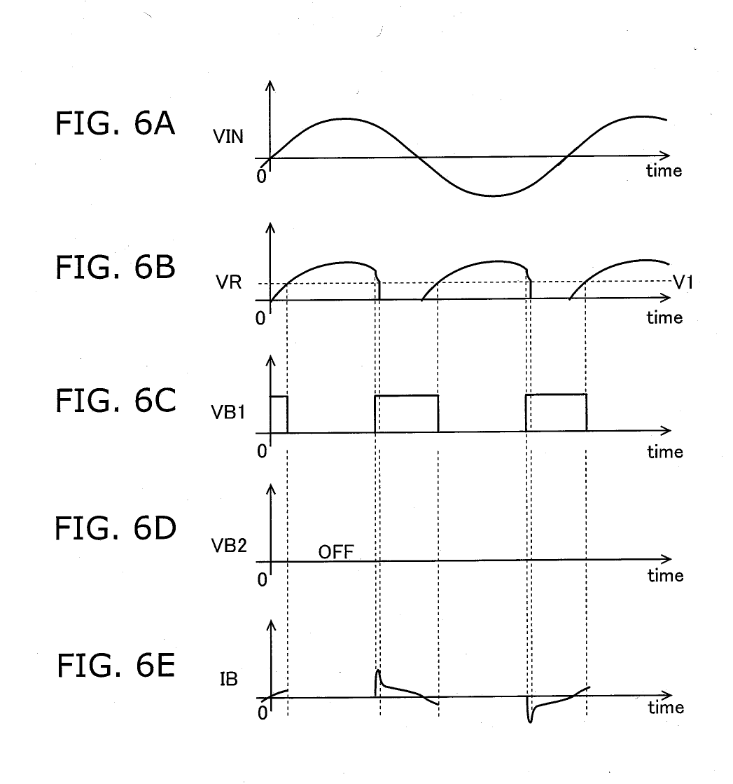

FIGS. 6A to 6E are waveform charts illustrating the main signals of an interface circuit when the reverse phase control dimmer 3b is present. Here, FIG. 6A shows a power source voltage VIN, FIG. 6B shows a detection voltage VR, FIG. 6C shows a first control signal VB1, FIG. 6D shows a second control signal VB2, and FIG. 6E shows an electric current 1B.

Since the embodiment has a configuration in which the reverse phase control dimmer 3b is present, an AC voltage VCT input to the interface circuit 1 is the same as the power source voltage VIN of the AC power source 2 when the dimmer 3b is in a conduction state. Further, the AC power source 2 is a commercial power source of a frequency of 50 Hz and a voltage of 100 V.

The power source voltage VIN of the AC power source 2 passes through the zero-crossing, and thus, for example, the power source voltage VIN has a phase where the input terminal 5 is a positive polarity and the input terminal 6 is a negative polarity (FIG. 6A). Since the dimmer 3b is in a cut off state, the absolute value of the AC voltage VCT maintains a small value, and the power source voltage VIN is applied to the dimmer 3b.

An operation until after the power source voltage VIN of the AC power source 2 passes through the zero-crossing, for example, the power source voltage VIN increases and the detection voltage VR reaches the specified value V1 from a state where the power source voltage VIN has the phase where the input terminal 5 is the positive polarity and the input terminal 6 is the negative polarity, is the same as in the case where the dimmer is not present described with reference to FIG. 4, except that the AC voltage VCT which is approximately the same as the power source voltage VIN is input to the input terminals 5 and 6 through the dimmer 3b which is in the conduction state.

In the period when the detection voltage VR is lower than the specified value V1, a high level is input as the first control signal VB1 (FIGS. 6B and 6C). The first circuit 43 is controlled to be turned on, and thus, the first electric current flows between the input terminals 5 and 6. Further, without being dependent on the detection voltage VR, a low level is input as the second control signal VB2 (FIG. 6D). As a result, the second circuit 44 is controlled to be turned off, and thus, the second electric current is cut off.

If time elapses and the phase of the power source voltage VIN proceeds, the detection voltage VR increases to be equal to or higher than the specified value V1 (see FIG. 6B). As the first control signal VB1, a low level is input (see FIG. 6C). The first circuit 43 is controlled to be turned off, and thus, the first electric current between the input terminals 5 and 6 is cut off. As described above, since the low level is constantly input as the second control signal VB2 (FIG. 6D), the second circuit 44 is controlled to be turned off, and the second electric current is thus cut off. As a result, the electric current IB between the input terminals 5 and 6 becomes zero (FIG. 6E).

Further, if time elapses and the phase of the power source voltage VIN proceeds, the dimmer 3b is in a cut off state and the detection voltage VR decreases (FIG. 6B). Here, during at least a period until the detection voltage VR is equal to or lower than the specified value V1, a high level is input as the first control signal VB1 (see FIG. 6C). The first circuit 43 allows the first electric current to flow between the input terminals 5 and 6. As a result, electric charges accumulated in a noise prevention capacitor which is connected between the input terminals 5 and 6 are discharged, to thereby make it possible to rapidly decrease the AC voltage VCT input to the input terminals 5 and 6 to zero.

If time elapses and the power source voltage VIN passes through the zero-crossing and the polarity of the power source voltage VIN is reversed, and thus, if the input terminal 5 is a negative polarity and the input terminal 6 is a positive polarity, the rectifier element 21 is turned off. In this case, operations are the same as in the above description except that the operations of the rectifier elements 21 and 22 and the operations of the resistors 23 and 24 are respectively replaced with each other.

Next, if the power source voltage VIN passes through the zero-crossing and the polarity of the power source voltage VIN is reversed, and thus, if the input terminal 5 is a positive polarity and the input terminal 6 is a negative polarity, the rectifier element 22 returns to the turned off state, and then, the same operations are repeated.

In the embodiment, a configuration is used in which in the period when the detection voltage VR is equal to or higher than the specified value V1, a low level is input as the first control signal VB1 and the first circuit 43 is controlled to be turned off. However, when the dimmer 3b is in the cut off state, the first circuit 43 may be controlled to be turned on during at least the period until the detection voltage VR is equal to or lower than the specified value V1, in the period when the detection voltage VR is equal to or higher than the specified value V1. For example, a configuration may be used in which a high level is input as the first control signal VB1 and the first circuit 43 is thus controlled to be turned on even in the period when the detection voltage VR is equal to or higher than the specified value V1.

In the embodiment, since the electric current IB flowing between the input terminals 5 and 6 is controlled by the first control signal VB1 and the second control signal VB2 input according to the presence or absence and the type of the dimmer, it is possible to stably operate the dimmer.

Further, in the embodiment, since the first electric current flows when the dimmer 3a is in the cut off state, corresponding to the case where the dimmer is the phase control dimmer 3a, it is possible to decrease the AC voltage VCT to about zero. As a result, it is possible to reliably set the dimmer 3a to the cut off state. Further, since the second electric current which is larger than the first electric current flows immediately after the dimmer 3a is in the conduction state, it is possible to reliably set the dimmer 3a to the conduction state without variation of the conduction state of the dimmer 3a.

Further, in the embodiment, since the first electric current flows when the dimmer 3b is in the cut off state from the conduction state, corresponding to the case where the dimmer is the reverse phase control dimmer 3b, it is possible to discharge electric charges accumulated in the noise removal capacitor connected between the input terminals 5 and 6. As a result, by decreasing the AC voltage VCT to about zero, it is possible to reliably set the dimmer 3b to the cutoff state.

Further, in the embodiment, a configuration is used in which the microprocessor (MPU) 32 is provided outside the interface circuit 1, the absolute value of the AC voltage is detected and output to the microprocessor 32 connected to the outside as the detection voltage VR, and the interface circuit 1 is controlled by the first control signal VB1, the second control signal VB2 or the like which is input from the microprocessor 32. However, a configuration in which the first control signal VB1 and the second control signal VB2 are generated inside the interface circuit 1 may be used.

### Second Embodiment

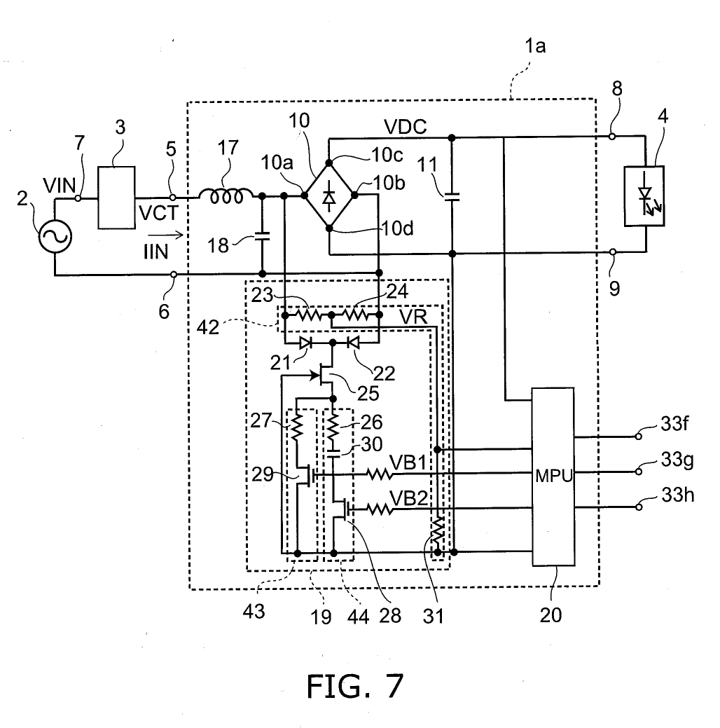

FIG. 7 is a circuit diagram illustrating an interface circuit according to a second embodiment.

In an interface circuit 1a according to the embodiment, a control circuit 20 is added to the interface circuit 1 according to the first embodiment. In the interface circuit 1a, a configuration except the control circuit 20 is the same as that of the interface circuit 1.

The control circuit 20 is a microprocessor, for example, and receives a signal indicating the presence or absence and the type of the dimmer from the outside to generate the first control signal VB1 and the second control signal VB2. Here, for example, the signal indicating the presence or absence and the type of the dimmer includes a first signal indicating that the AC voltage VCT is subject to reverse phase control by the dimmer 3b, a second signal indicating that the AC voltage VCT is subject to phase control by the dimmer 3a, and a third signal indicating the AC voltage VCT which is continuous in phase without passing through the dimmer. For example, the first signal is input through a terminal 33f, the second signal is input through a terminal 33g, and the third signal is input through a terminal 33h, respectively. The control signal 20 may have the same configuration as that of the microprocessor connected to the outside of the interface circuit in the first embodiment.

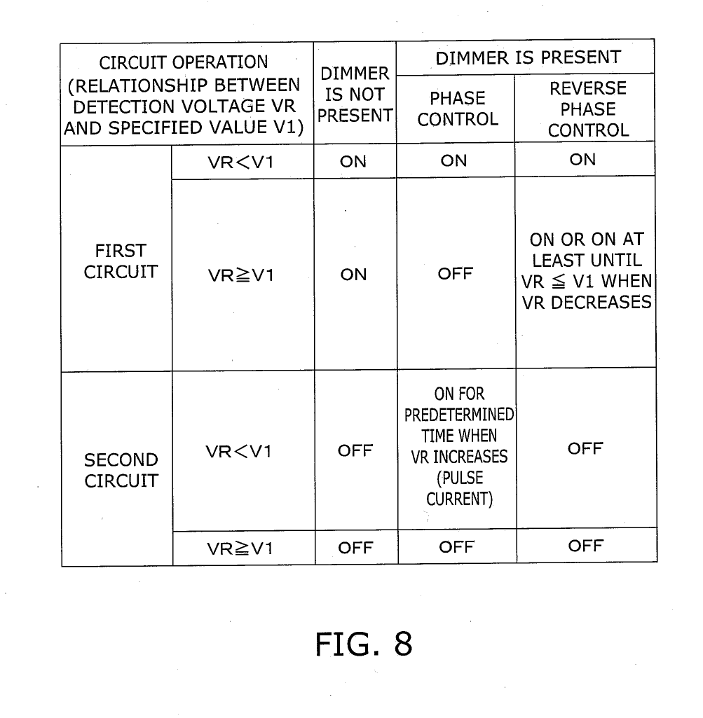

FIG. 8 is a diagram schematically illustrating operations of a load circuit in an interface circuit.

The first circuit 43 and the second circuit 44 receive the first control signal VB1 and the second control signal VB2 output from the control circuit 20, respectively, and operate as shown in FIG. 8.

In many cases, the presence or absence and the type of the dimmer are constant for a relatively long time after being detected once as in the case where the AC power source is a commercial power source, for example, and may be set as the first to third signals from the outside, for example. Since the control circuit 20 generates the first control signal VB1 and the second control signal VB2 according to the presence or absence and the type of the dimmer, handling is easy.

In this way, in the embodiment, since the control circuit 20 is provided, it is easy to cope with the presence or absence and the type of the dimmer.

### Third Embodiment

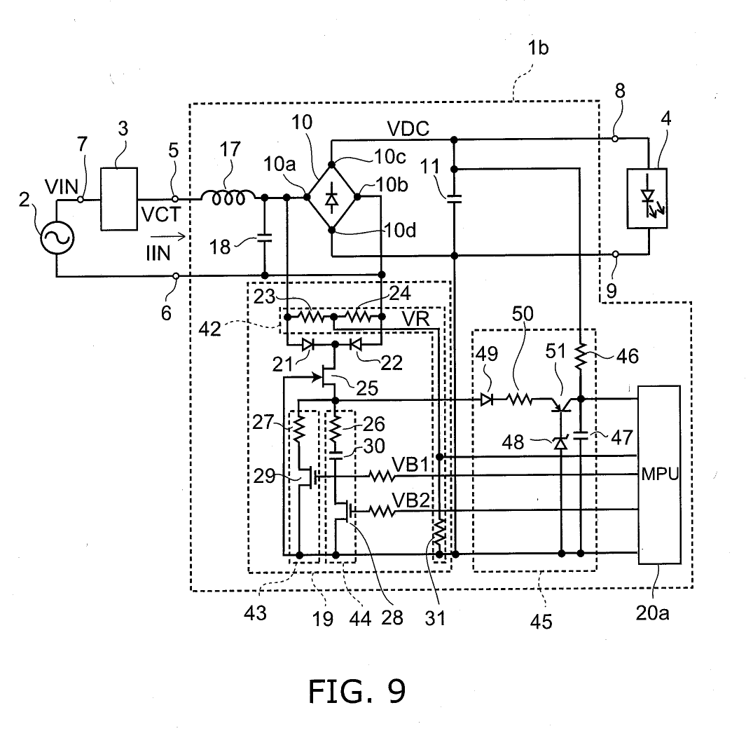

FIG. 9 is a circuit diagram illustrating an interface circuit according to a third embodiment.

In an interface circuit 1b according to the embodiment, a control circuit 20a is provided instead of the control circuit 20 in the interface circuit 1a of the second embodiment, and a power source circuit 45 is added.

In the interface circuit 1b, a configuration except the control circuit 20a and the power source circuit 45 is the same as the configuration of the interface circuit 1a.

The control circuit 20a is different in that the control circuit 20a does not receive the first to third signals indicating the presence or absence and the type of the dimmer but receives detection voltage VR and an electric potential of a high electric potential terminal 10c to generate the first control signal VB1 and the second control signal VB2, compared with the control circuit 20. The control circuit 20a includes a microprocessor, for example.

A power source circuit 45 supplies electric power to the control circuit 20a. The power source circuit 45 includes resistors 46 and 50, a capacitor 47, a Zener diode 48, a diode 49 and a transistor 51. The resistor 46 and the capacitor 47 form a smoothing circuit, and supply a smoothed voltage to the control circuit 20a. Further, the Zener diode 48 and the transistor 51 form a stabilizing power source. The diode 49 is a protection diode. In the embodiment, a configuration is shown in which a PNP transistor is used as the transistor 51 and a reference voltage is generated in the Zener diode 48, but any, configuration may be used as long as a stabilized voltage can be supplied to the control circuit.

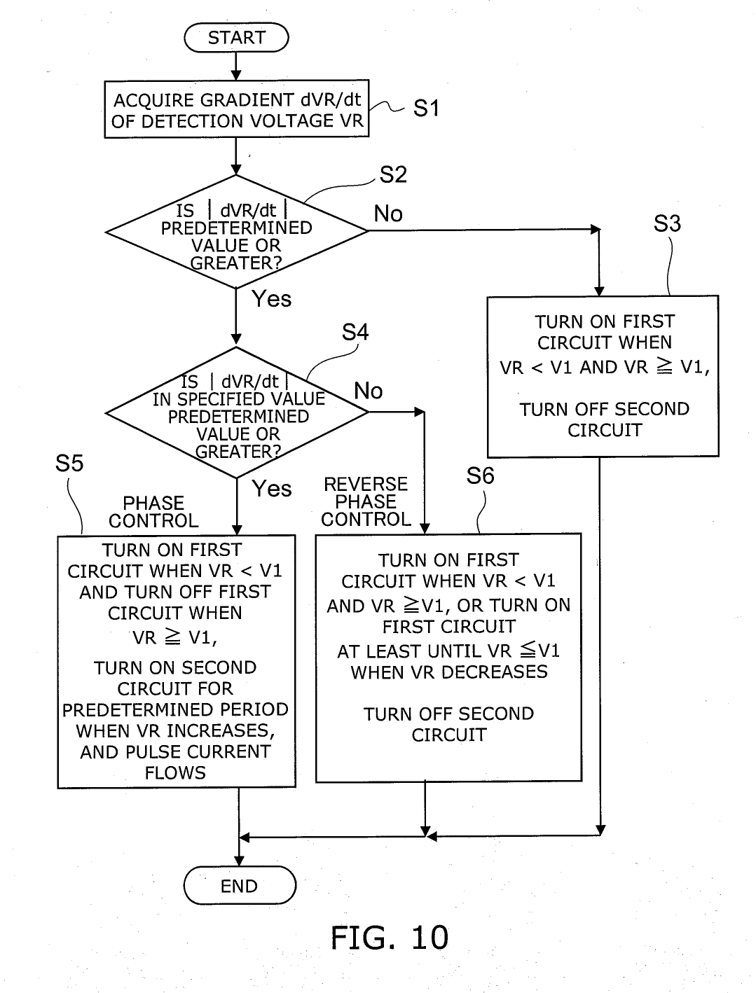

FIG. 10 is a flowchart illustrating an operation of the control circuit.

Firstly, the control circuit 20a receives the detection voltage VR to acquire a gradient dVR/dt (Act 1).

Then, the control circuit 20a compares an absolute value |dVR/dt| of the detected gradient dVR/dt with a predetermined value, and determines whether the absolute value |dVR/dt| is equal to or greater than the predetermined value (Act 2).

When the absolute value |dVR/dt| of the gradient is equal to or greater than the predetermined value, it is determined that the dimmer is present (Act 2: Yes). When the AC voltage VCT is subject to phase control by the dimmer 3a, the gradient of the detection voltage VR is rapidly changed when the dimmer 3a is changed to the conduction state from the cut off state. Further, when the AC voltage VCT is subject to reverse phase control by the dimmer 3b, the gradient of the detection voltage VR is rapidly changed when the dimmer 3b is changed to the cut off state from the conduction state. On the other hand, if the dimmer is not present, the detection voltage VR substantially forms a sine wave, and the gradient of the detection voltage VR is not rapidly changed and is lower than the predetermined value. Thus, in the embodiment, if the absolute value |dVR/dt| of the gradient is equal to or greater than the predetermined value, it is determined that the dimmer is present (Act 2: Yes), and if the absolute value |dVR/dt| of the gradient is smaller than the predetermined value, it is determined that the dimmer is not present (Act 2: No).

If it is determined that the dimmer is not present (Act 2: No), the procedure proceeds to act 3, the first control signal VB1 for controlling the first circuit 43 to be turned on and the second control signal VB2 for controlling the second circuit 44 to be turned off are generated, and then, the procedure ends (Act 3).

Further, if it is determined that the dimmer is present (Act 2: Yes), the procedure proceeds to act 4, and then, it is determined whether the gradient dVR/dt in the specified value V1 of the detection voltage VR is equal to or greater than the predetermined value (Act 4).

If the gradient dVR/dt in the specified value V1 of the detection voltage VR is equal to or greater than the predetermined value, it is determined that the AC voltage VCT is subject to phase control by the dimmer 3a (Act 4: Yes). When the AC voltage VCT is subject to phase control by the dimmer 3a, the dimmer 3a is changed to the conduction state from the cut off state, and the gradient of the detection voltage VR is rapidly changed when the detection voltage VR is equal to or greater than the specified value V1. Further, when the AC voltage VCT is subject to reverse phase control by the dimmer 3b, the gradient of the detection voltage VR is not rapidly changed in a similar way to the case where the dimmer is not present when the detection voltage VR is equal to or greater than the specified value V1. Thus, if the gradient dVR/dt in the specified value V1 of the detection voltage VR is equal to or greater than the predetermined value, it is determined that the AC voltage VCT is subject to phase control by the dimmer 3a (Act 4: Yes), and if the gradient dVR/dt is smaller than the predetermined value, it is determined that the AC voltage VCT is subject to reverse phase control by the dimmer 3b (Act 4: No).

If it is determined that the AC voltage VCT is subject to phase control by the dimmer 3a (Act 4: Yes), the procedure proceeds to act 5, and the first control signal VB1 is generated for controlling the first circuit 43 to be turned on when the detection voltage VR is lower than the specified value V1 and to be turned off when the detection voltage VR is equal to or greater than the specified value V1 (Act 5). Further, the second control signal VB2 is generated for controlling the second circuit 44 to be turned on for a predetermined period when the detection voltage VR is equal to or greater than the specified value V1, and then the procedure ends (Act 5).

If it is determined that the AC voltage VCT is subject to reverse phase control by the dimmer 3b (Act 4: No), the procedure proceeds to act 6, and the first control signal VB1 is generated for controlling the first circuit 43 to be turned on when the detection voltage VR is lower than the specified value V1 and to be turned on at least until the detection voltage VR decreases to be equal to or lower than the specified value V1 when the detection voltage VR is equal to or greater than the specified value V1 (Act 6). Further, the second control signal VB2 is generated for controlling the second circuit 44 to be turned off, and the procedure ends (Act 6).

In the embodiment, the presence or absence of the dimmer is detected on the basis of the gradient dVR/dt of the detection voltage VR, and it is detected whether the AC voltage VCT is subject to phase control or reverse phase control on the basis of the gradient of the detection voltage VR when the detection voltage VR is increased to be equal to or greater than the specified value V1.

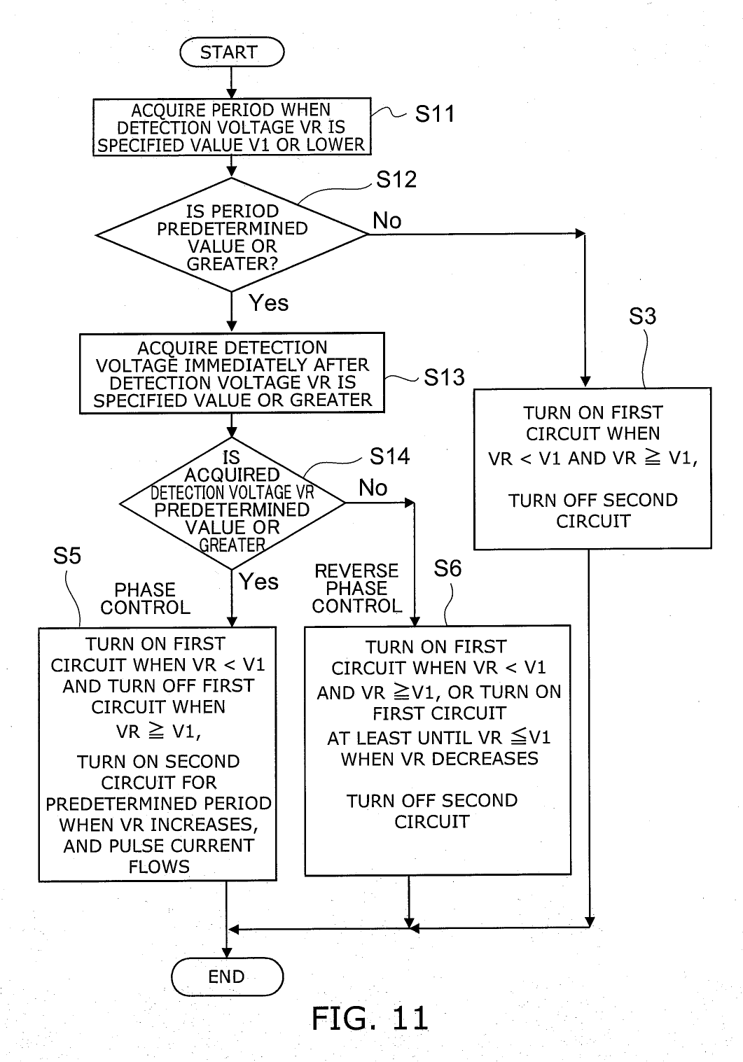

FIG. 11 is another flowchart illustrating an operation of the control circuit.

Firstly, the control circuit 20a receives the detection voltage VR and acquires the length of the period when the detection voltage VR is equal to or lower than the specified value V1 (Act 11).

Next, the acquired length of the period is compared with a predetermined value, and it is determined whether the acquired length of the period is equal to or greater than the predetermined value (Act 12).

If the acquired length of the period is equal to or greater than the predetermined value, it is determined that a dimmer is present (Act 12: Yes).

As described above with reference to FIG. 2, the phase control dimmer 3a has a minimum duration of the period when the detection voltage VR is equal to or lower than the specified value V1, corresponding to 10% to 25% of the cycle of the AC voltage VCT (half cycle of the power source voltage VIN). When the frequency of the AC power source 2 is 50 Hz, the half cycle is 10 ms, and the minimum duration is 1 ms to 2.5 ms, for example. Further, as described above with reference to FIG. 3, the reverse phase control dimmer 3b has a minimum duration of the period when the detection voltage VR is equal to or lower than the specified value V1, corresponding to 10% to 35% of the cycle of the AC voltage VCT (half cycle of the power source voltage VIN). When the frequency of the AC power source 2 is 50 Hz, the minimum duration is 1 ms to 2.5 ms, for example.

Accordingly, for example, by determining the period when the detection voltage VR is equal to or lower than the specified value V1 using a threshold of 0.5 ms with respect to a value when the dimmer is not present, it is possible to detect the presence or absence of the dimmer. Thus, in the specific example, if the length of the period when the detection voltage VR is equal to or lower than the specified value V1 is equal to or greater than the predetermined value, it is determined that the dimmer is present (Act 12: Yes), and if the length is shorter than the predetermined value, it is determined that the dimmer is not present (Act 12: No).

If it is determined that the dimmer is not present (Act 12: No), the procedure proceeds to act 3. Then, the first control signal VB1 for controlling the first circuit 43 to be turned on and the second control signal VB2 for controlling the second circuit 44 to be turned off are generated, and then, the procedure ends (Act 3). Act 3is the same as act 3 described with reference to FIG. 10.

Further, if it is determined that the dimmer is present (Act 12: Yes), the procedure proceeds to act 13, and the detection voltage VR immediately after the detection voltage VR is equal to or greater than the specified value V1 is acquired (Act 13).

Next, it is acquired whether the detection voltage VR immediately after the detection voltage VR is equal to or greater than the specified value V1, i.e., the acquired detection voltage VR is equal to or greater than a predetermined value (Act 14).

As described with reference to act 4 in FIG. 10, when the AC voltage VCT is subject to phase control by the dimmer 3a, the dimmer 3a is changed to the conduction state from the cut off state, and thus, the gradient of the detection voltage VR is rapidly changed when the detection voltage VR is equal to or greater than the specified value V1. As a result, the detection voltage VR immediately after the detection voltage VR is equal to or greater than the specified value V1 becomes a relatively large value. Further, when the AC voltage VCT is subject to reverse phase control by the dimmer 3b, in a similar way to the case where the dimmer is not present, when the detection value VR is equal to or greater than the specified value V1, the gradient of the detection voltage VR is not rapidly changed. As a result, the detection voltage VR immediately after the detection voltage VR is equal to or greater than the specified value V1 becomes a relatively small value. Thus, if the detection voltage VR immediately after the detection voltage VR is equal to or greater than the specified value V1 is equal to or greater than the predetermined value, it is determined that the AC voltage VCT is subject to phase control by the dimmer 3a (Act 14: Yes), and if the detection voltage VR immediately after the detection voltage VR is equal to or greater than the specified value V1 is lower than the predetermined value, it is determined that the AC voltage VCT is subject to reverse phase control by the dimmer 3b (Act 14: No).

If it is determined that the AC voltage VCT is subject to phase control by the dimmer 3a (Act 14: Yes), the procedure proceeds to act 5. Then, the first control signal VB1 is generated for controlling the first circuit 43 to be turned on when the detection voltage VR is lower than the specified value V1 and to be turned off when the detection voltage VR is equal to or greater than the specified value V1 (Act 5). Further, when the detection voltage VR is equal to or greater than the specified value V1, the second control signal VB2 for controlling the second circuit 44 to be turned on for a predetermined period of time, and then, the procedure ends (Act 5). Act 5is the same as act 5 described with reference to FIG. 10.

If it is determined that the AC voltage VCT is subject to reverse phase control by the dimmer 3b (Act 14: No), the procedure proceeds to act 6. Then, the first control signal VB1 is generated for controlling the first circuit 43 to be turned on when the detection voltage VR is lower than the specified value V1 and to be turned on at least until the detection voltage VR decreases to be equal to or lower than the specified value V1 when the detection voltage VR is equal to or greater than the specified value V1(Act 6). Further, the second control signal VB2 for controlling the second circuit 44 to be turned off is generated, and then, the procedure ends (Act 6). Act 6is the same as act 6 described with reference to FIG. 10.

In the embodiment, the presence or absence of the dimmer is detected on the basis of the length of the period when the detection voltage VR is equal to or lower than the specified value V1, and it is detected whether the AC voltage VCT is subject to phase control or reverse phase control on the basis of the detection voltage VR immediately after the detection voltage VR is equal to or greater than the specified value V1.

In the above description, the specific example in which the presence or absence of the dimmer is detected on the basis of the length of the period when the detection voltage VR is equal to or lower than the specified value V1 or on the basis of the gradient dVR/dt of the detection voltage VR is described. Further, the specific example in which the type of the dimmer is detected on the basis of the detection voltage VR immediately after the detection voltage VR is equal to or greater than the specified value V1 or on the basis of the gradient of the detection voltage VR when the detection voltage VR is equal to or greater than the specified value V1 is described. However, in addition to the combinations described in the above embodiments, another arbitrary combination may be used.

In the embodiment, it is detected whether the AC voltage VCT is subject to phase control or reverse phase control, or is continuous in phase, on the basis of at least one of the length of the period when the detection voltage is lower than the specified value V1, the gradient dVR/dt of the detection voltage VR and the voltage value immediately after the detection voltage VR is equal to or greater than the specified value V1, to generate the first control signal VB1 and the second control signal VB2. As a result, without receiving signals indicating the presence or absence and the type of the dimmer from the outside, it is possible to achieve the same effect as in the first embodiment.

Hereinbefore, the embodiments have been described with reference to the specific examples, but the embodiments are not limited, and various modifications may be used.

For example, in each embodiment, the configuration is shown in which the first control signal VB1 and the second control signal VB2 employ the binary signals of the high level and the low level, but a configuration may be used in which the first control signal VB1 and the second control signal VB2 employ analog signals capable of being continuously changed, for example, multiple value signals capable of being gradually changed to control the current value of the first electric current and the current value of the second electric current. For example, a configuration may be used in which the first control signal VB1 is changed so that as the detection voltage VR increases, the first electric current decreases, to provide a constant power characteristic to the first circuit 43. For example, when the dimmer is not present, or in similar cases, since the first circuit 43 is controlled to be continuously turned on, by providing the constant power characteristic, it is possible to reduce power consumption.

Further, the switching element 25 may be a normally-on type, and may employ a HEMT in addition to the MOSFET. Further, the HEMT is not limited to a GaN-type HEMT. For example, the HEMT may be a semiconductor device formed by applying a semiconductor having a wide band gap (wide band gap semiconductor), such as silicon carbide (SiC), gallium nitride (GaN) or diamond to a semiconductor substrate. Here, the wide band gap semiconductor refers to a semiconductor having a wide band gap compared with gallium arsenide (GaAs) with a band gap of about 1.4 eV. For example, a semiconductor with a band gap of 1.5 eV or higher, gallium phosphide (GaP, band gap of about 2.3 eV), gallium nitride (GaN, band gap of about 3.4 eV), diamond (C, band gap of about 5.27 eV), aluminum nitride (AlN, band gap of about 5.9 eV), silicon carbide (SiC) or the like may be used. Since a semiconductor device with such a wide band gap may be smaller in size than a silicon semiconductor device when a withstand voltage is set to be equal, it is possible to achieve a small-sized interface circuit.

The embodiments and examples have been described, but these embodiments and examples are only exemplary and do not limit the scope of the invention. These new embodiments and examples may be realized as other various embodiments and examples. Further, various omissions, replacements or modifications may be made within a range without departing from the spirit of the invention. The embodiments and examples, and modifications thereof are included in the scope or spirit of the invention, and are included in the inventions disclosed in claims and equivalents thereof.

What is claimed is:

1. An interface circuit comprising:
a rectifier circuit configured to rectify an AC voltage input between a pair of input terminals, the AC voltage which is subject to phase control or reverse phase control by a dimmer or the AC voltage which is continuous in phase without passing through the dimmer;
a detection circuit configured to detect the AC voltage and output the result as a detection voltage;
a first circuit configured to be controlled to be turned on or turned off on the basis of a first control signal input, to cause a first electric current to flow between the pair of input terminals in an on state and to cut off the first electric current in an off state; and
a second circuit configured to be controlled to be turned on or turned off on the basis of a second control signal input, to cause a second electric current which is greater than the first electric current to flow between the pair of input terminals in an on state and to cut off the second electric current in an off state.

2. The circuit according to claim 1, further comprising a control circuit which generates the first control signal and the second control signal,
the first circuit being controlled to be turned on when the detection voltage is lower than a specified value, and being controlled to be turned on at least until the detection voltage decreases to be equal to or less than the specified value when the detection value is equal to or greater than the specified value, and
the second circuit being controlled to be turned off.

3. The circuit according to claim 1, further comprising a control circuit which generates the first control signal and the second control signal,
the first circuit being controlled to be turned on when the detection voltage is lower than a specified value, and is controlled to be turned off when the detection value is equal to or greater than the specified value, and
the second circuit being controlled to be turned on during a predetermined period when the detection value is equal to or greater than the specified value.

4. The circuit according to claim 1, further comprising a control circuit which generates the first control signal and the second control signal,
the first circuit being controlled to be turned on, and
the second circuit being controlled to be turned off.

5. The circuit according to claim 2,
wherein the control circuit detects whether the AC voltage is subject to phase control or reverse phase control, or is continuous in phase, on the basis of at least one of the length of a period when the detection voltage is lower than the specified value, a gradient of the detection voltage when the detection voltage is increased to be equal to or greater than the specified value, and a voltage value immediately after the detection voltage is increased to be equal to or greater than the specified value.

6. The circuit according to claim 3,
wherein the control circuit detects whether the AC voltage is subject to phase control or reverse phase control, or is continuous in phase, on the basis of at least one of the length of a period when the detection voltage is lower than the specified value, a gradient of the detection voltage when the detection voltage is increased to be equal to or greater than the specified value, and a voltage value immediately after the detection voltage is increased to be equal to or greater than the specified value.

7. The circuit according to claim 4,
wherein the control circuit detects whether the AC voltage is subject to phase control or reverse phase control, or is continuous in phase, on the basis of at least one of the length of a period when the detection voltage is lower than the specified value, a gradient of the detection voltage when the detection voltage is increased to be equal to or greater than the specified value and a voltage value immediately after the detection voltage is increased to be equal to or greater than the specified value, and output the first control signal and the second control signal.

8. The circuit according to claim 1,
wherein the first circuit has a constant power characteristic in which the first electric current decreases when the detection voltage increases.

9. The circuit according to claim 1, further comprising a switching element connected to the pair of input terminals through a pair of rectifier elements,
the first circuit causing electric current to flow through the switching element.

10. The circuit according to claim 1, further comprising a control circuit which generates the first control signal and the second control signal, and detects the presence or absence of the dimmer on the basis of a gradient of the detection voltage.

11. The circuit according to claim 1, further comprising a control circuit which generates the first control signal and the second control signal, and detects whether the AC voltage is subject to phase control or reverse phase control on the basis of a gradient of the detection voltage when the detection voltage increases to be equal to or higher than a specified value.

12. The circuit according to claim 1, further comprising a control circuit which generates the first control signal and the second control signal, and detects the presence or absence of the dimmer on the basis of a length of a period when the detection voltage is lower than a specified value.

13. The circuit according to claim 1, further comprising a control circuit which generates the first control signal and the second control signal, and detects whether the AC voltage is subject to phase control or reverse phase control on the basis of a gradient of the detection voltage.

14. The circuit according to claim 1, further comprising a control circuits which generates the first control signal and the second control signal, and controls a current value of the first electric current depending on an electric potential of the first control signal.

15. An interface method of interfacing an AC voltage input between a pair of input terminals, the AC voltage which is subject to phase control or reverse phase control by a dimmer or the AC voltage which is continuous in phase without passing through the dimmer, comprising:
rectifying the AC voltage;
detecting the AC voltage and outputting the result as a detection voltage;
causing a first electric current to flow between the pair of input terminals during a predetermined period on the basis of the detection voltage and a first control signal; and
causing a second electric current which is greater than the first electric current to flow between the pair of input terminals on the basis of the detection voltage and a second control signal.

16. A method of generating an output voltage for a light emitting element with an interface circuit having a pair of input terminals connected to an AC voltage source and a pair of output terminals connected to the light emitting element, comprising:
determining whether the AC voltage is: (1) continuous in phase, (2) subject to phase control, or (3) subject to reverse phase control;
rectifying the AC voltage;
detecting the AC voltage and outputting the result as a detection voltage;
causing a first electric current to flow between the pair of input terminals during a predetermined period on the basis of the detection voltage and a first control signal; and
causing a second electric current which is greater than the first electric current to flow between the pair of input terminals on the basis of the detection voltage and a second control signal,
wherein the first and second control signals are generated according to said determining.

17. The method according to claim 16, wherein said determining is based on a length of a period when the detection voltage is lower than a specified value, and a gradient of the detection voltage.

18. The method according to claim 17, wherein the AC voltage is determined to be continuous in phase, and the first electric current is caused to flow between the pair of input terminals and the second electric current is not caused to flow between the pair of input terminals.

19. The method according to claim 17, wherein the AC voltage is determined to be subject to phase control, and the first electric current is caused to flow between the pair of input terminals when the detection voltage is lower than a specified value and to stop flowing between the pair of input terminals when the detection voltage is equal to or greater than the specified value, and the second electric current is caused to flow when the detection voltage is equal to or greater than the specified value.

20. The method according to claim 17, wherein the AC voltage is determined to be subject to reverse phase control, and the first electric current is caused to flow between the pair of input terminals when the detection voltage is lower than a specified value and to flow between the pair of input terminals for a predetermined period of time at least until the detection voltage decreases to be equal to or less than the specified value when the detection voltage is equal to or greater than the specified value, and the second electric current is caused to stop flowing between the pair of input terminals.
